(19) United States
(12) Patent Application Publication
(10) Pub. No.: US 2014/0111166 A1
(43) Pub. Date: Apr. 24, 2014

(54) CIRCUITS FOR CHARGING BATTERIES AND BOOSTING VOLTAGES OF BATTERIES, AND METHODS OF CHARGING BATTERIES

(71) Applicant: SAMSUNG ELECTRONICS CO., LTD., Suwon-Si (KR)

(72) Inventors: Jae-jung YUN, Hwaseong-si (KR); Tae-jung YEO, Seoul (KR); Jong-soo KIM, Suwon-si (KR); Jang-pyo PARK, Busan (KR)

(73) Assignee: Samsung Electronics Co., Ltd., Suwon-Si (KR)

(21) Appl. No.: 13/855,195

(22) Filed: Apr. 2, 2013

(30) Foreign Application Priority Data
Oct. 24, 2012 (KR) 10-2012-0118675

(51) Int. Cl. H02J 7/00

(52) U.S. Cl. CPC H02J 7/0052
USPC 320/162; 320/137

(57) ABSTRACT

A circuit may comprise a direct current (DC)/DC boost converter connected to a battery that includes a plurality of cells; a DC link connected between the DC/DC boost converter and an inverter; and/or a charging circuit connected between the battery and the DC link. The charging circuit may be connected to the DC/DC boost converter in parallel. A method of charging a battery using a regenerative energy of a motor may include storing the regenerative energy of the motor by using a converter with a multi-winding transformer, selecting a cell to be charged from among a plurality of cells included in the battery, and transferring the stored regenerative energy to the selected cell by using the converter.

### CROSS-REFERENCE TO RELATED APPLICATION(S)

This application claims priority from Korean Patent Application No. 10-2012-0118675, filed on Oct. 24, 2012, in the Korean Intellectual Property Office (KIPO), the entire contents of which are incorporated herein by reference.

### BACKGROUND

1. Field

Some example embodiments may relate to circuits for charging batteries and boosting voltages of batteries, and methods of charging batteries.

2. Description of Related Art

In order to improve the mileage of electric vehicles, a driving motor charges a battery as an electric generator when the vehicle decreases its speed. Here, a battery is configured by connecting stacks, in which a plurality of single cells are connected in series, in parallel with each other, in order to obtain a high voltage and a large capacity. The plurality of cells ideally all have to have the same characteristics as each other; however, deviations between cells (differences in capacity and impedance) may occur due to technical and economical limitations when fabricating the cells. Such deviations increase when a temperature difference between cells and the number of charging or discharging operations increase. Due to the deviations between cells, cells having less capacity than others may be over-charged or over-discharged during a charging or discharging operation, and thus, a balancing operation for balancing voltages of the cells is necessary.

### SUMMARY

Some example embodiments may provide circuits for charging batteries and/or boosting voltages of batteries.

Some example embodiments may provide circuits and/or methods of performing balancing between cells included in batteries to reduce differences between voltages and/or states of charges, and/or to simultaneously charge the batteries.

In some example embodiments, a circuit may comprise a direct current (DC)/DC boost converter connected to a battery that includes a plurality of cells; a DC link connected between the DC/DC boost converter and an inverter; and/or a charging circuit connected between the battery and the DC link. The charging circuit may be connected to the DC/DC boost converter in parallel.

In some example embodiments, the circuit may further comprise a diode connected between the DC/DC boost converter and the DC link.

In some example embodiments, the charging circuit may include a second converter with a multi-winding transformer.

In some example embodiments, the second converter may comprise a first inductor connected to the DC link; a second inductor connected to each of the plurality of cells in parallel; a first switch connected to the first inductor in series; and/or a second switch connected to the second inductor in series.

In some example embodiments, a number of windings of the first inductor may be greater than a number of windings of the second inductor.

In some example embodiments, the charging circuit may comprise a measuring device configured to measure voltages, states of charges (SOCs), or voltages and SOCs of the plurality of cells.

In some example embodiments, the charging circuit may further comprise a control device configured to control turning on and turning off of the first switch, and/or configured to control turning on and turning off of the second switch.

In some example embodiments, the control device may be configured to control the first switch based on the voltages, the SOCs, or the voltages and the SOCs measured by the measuring device, and/or may be configured to control the second switch based on the voltages, the SOCs, or the voltages and SOCs measured by the measuring device.

In some example embodiments, the second converter may further comprise a reset circuit connected to the first inductor in parallel. The reset circuit may comprise a diode and/or a mutual inductor having a polarity opposite to a polarity of the first inductor.

In some example embodiments, when the battery is discharging, the DC/DC boost converter may boost a voltage of the battery and/or may transfer the boosted voltage to the DC link.

In some example embodiments, a method of charging a battery using a regenerative energy of a motor may comprise storing the regenerative energy of the motor by using a converter with a multi-winding transformer; selecting a cell to be charged from among a plurality of cells included in the battery; and/or transferring the stored regenerative energy to the selected cell by using the converter.

In some example embodiments, the selecting of the cell may comprise selecting one of the plurality of cells based on voltages, states of charges (SOCs), or voltages and SOCs of the plurality of cells.

In some example embodiments, the transferring of the stored regenerative energy may comprise transferring the stored regenerative energy to the selected cell by controlling turning on and turning off of a switch connected to the selected cell.

In some example embodiments, the selecting of the cell may comprise selecting one of the plurality of cells having a lowest voltage or a lowest state of charge (SOC).

In some example embodiments, a computer-readable recording medium may have embodied thereon a program for executing the method in a computer.

In some example embodiments, a circuit may comprise a direct current (DC) link configured to connect to an inverter; a DC/DC boost converter configured to connect between the DC link and a battery that includes a plurality of cells; and/or a charging circuit configured to connect between the DC link and the battery. When the battery is discharging via the circuit, energy may flow from the battery through the DC/DC boost converter to the DC link. When the battery is charging via the circuit, energy may flow from the DC link through the charging circuit to the battery.

In some example embodiments, the circuit may further comprise a diode between the DC/DC boost converter and the DC link.

In some example embodiments, the charging circuit may comprise a second converter.

In some example embodiments, the charging circuit may comprise a second converter with a multi-winding transformer.

In some example embodiments, the charging circuit may comprise a measuring device configured to measure voltages, states of charges (SOCs), or voltages and SOCs of the plurality of cells.

In some example embodiments, the charging circuit may comprise a measuring device configured to measure a voltage of each cell of the plurality of cells.

In some example embodiments, the charging circuit may comprise a measuring device configured to measure a state of charge (SOC) of each cell of the plurality of cells.

In some example embodiments, the charging circuit may comprises a second converter; a measuring device configured to measure voltages, states of charges (SOCs), or voltages and SOCs of the plurality of cells; and/or a control device configured to control the second converter based on the measured voltages, SOCs, or voltages and SOCs of the plurality of cells.

### BRIEF DESCRIPTION OF THE DRAWINGS

The above and/or other aspects and advantages will become more apparent and more readily appreciated from the following detailed description of example embodiments, taken in conjunction with the accompanying drawings, in which:

FIG. 1 is a diagram showing an electric circuit for driving a motor according to some example embodiments;

FIG. 2 is a diagram showing the circuit of FIG. 1 according to some example embodiments;

FIG. 3 is a diagram showing the circuit of FIG. 1 according to some example embodiments;

FIG. 4 is a diagram showing the circuit of FIG. 1 according to some example embodiments;

FIG. 5 is a diagram showing the converter of FIG. 4 according to some example embodiments;

FIG. 6 is a diagram showing the converter of FIG. 4 according to some example embodiments; and

FIG. 7 is a flowchart for illustrating operations of the electric circuit of FIG. 2 according to some example embodiments.

### DETAILED DESCRIPTION

Example embodiments will now be described more fully with reference to the accompanying drawings. Embodiments, however, may be embodied in many different forms and should not be construed as being limited to the embodiments set forth herein. Rather, these example embodiments are provided so that this disclosure will be thorough and complete, and will fully convey the scope to those skilled in the art. In the drawings, the thicknesses of layers and regions may be exaggerated for clarity.

It will be understood that when an element is referred to as being “on,” “connected to,” “electrically connected to,” or “coupled to” to another component, it may be directly on, connected to, electrically connected to, or coupled to the other component or intervening components may be present. In contrast, when a component is referred to as being “directly on,” “directly connected to,” “directly electrically connected to,” or “directly coupled to” another component, there are no intervening components present. As used herein, the term “and/or” includes any and all combinations of one or more of the associated listed items.

It will be understood that although the terms first, second, third, etc., may be used herein to describe various elements, components, regions, layers, and/or sections, these elements, components, regions, layers, and/or sections should not be limited by these terms. These terms are only used to distinguish one element, component, region, layer, and/or section from another element, component, region, layer, and/or section. For example, a first element, component, region, layer, and/or section could be termed a second element, component, region, layer, and/or section without departing from the teachings of example embodiments.

Spatially relative terms, such as “beneath,” “below,” “lower,” “above,” “upper,” and the like may be used herein for ease of description to describe the relationship of one component and/or feature to another component and/or feature, or other component(s) and/or feature(s), as illustrated in the drawings. It will be understood that the spatially relative terms are intended to encompass different orientations of the device in use or operation in addition to the orientation depicted in the figures.

The terminology used herein is for the purpose of describing particular example embodiments only and is not intended to be limiting of example embodiments. As used herein, the singular forms “a,” “an,” and “the” are intended to include the plural forms as well, unless the context clearly indicates otherwise. It will be further understood that the terms “comprises,” “comprising,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

Example embodiments may be described herein with reference to cross-sectional illustrations that are schematic illustrations of idealized example embodiments (and intermediate structures). As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. For example, an implanted region illustrated as a rectangle will typically have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature, their shapes are not intended to illustrate the actual shape of a region of a device, and their shapes are not intended to limit the scope of the example embodiments.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and should not be interpreted in an idealized or overly formal sense unless expressly so defined herein.

Reference will now be made to example embodiments, which are illustrated in the accompanying drawings, wherein like reference numerals may refer to like components throughout.

FIG. 1 is a diagram showing an electric circuit 100 for driving a motor 140 according to some example embodiments. Referring to FIG. 1, the electric circuit 100 includes a battery 110, a circuit 120, and an inverter 130. FIG. 1 only shows components of the electric circuit 100 that are related to the present embodiment. However, one of ordinary skill in the art would comprehend that the electric circuit 100 can further include other universal components, in addition to the components shown in FIG. 1.

The battery 110 includes a plurality of cells that store energy and may be reused after being recharged. The battery 110 supplies energy to the motor 140 or is charged by regenerative energy generated by the motor 140. When charging or discharging the battery 110, a voltage difference may occur between the plurality of cells in the battery 110.

The circuit 120 boosts a voltage of the battery 110 to supply the energy to the motor 140 via the inverter 130. Also, the circuit 120 selectively charges the cells of the battery 110 by using the regenerative energy of the motor 140 to perform a balancing operation of the battery 110. The circuit 120 repeatedly charges the cells that are not balanced with each other, and thus, performs the charging and balancing of the cells at the same time. A cell that is not balanced denotes a cell having a different voltage or a different state of charge (SOC) from those of other cells. That is, the circuit 120 selects a cell having the lowest voltage or the lowest SOC from among the plurality of cells, and charges the selected cell to make the voltages or the SOCs of the cells equal to each other.

The circuit 120 regularly measures the voltages or the SOCs of the cells, and performs the balancing operation based on the measured voltages or the SOCs. The circuit 120 repeatedly charges the cell having the lowest voltage or the lowest SOC among the cells. Then, the cells have voltages that are equal to each other, and the battery 110 is charged.

The inverter 130 transmits the energy transmitted from the circuit 120 to the motor 140, or transmits the energy transmitted from the motor 140 to the circuit 120. The inverter 130 converts direct current (DC) to alternating current (AC), or vice versa. That is, the inverter 130 converts DC (or DC voltage) transmitted from the circuit 120 into AC (or AC voltage), and transmits it to the motor 140. Otherwise, the inverter 130 converts AC (or AC voltage) transmitted from the motor 140 into DC (or DC voltage), and transmits it to the circuit 120. When the inverter 130 transmits the energy from the circuit 120 to the motor 140, the battery 110 is discharged. When the inverter 130 transmits the regenerative energy from the motor 140 to the circuit 120, the battery 110 is charged.

The motor 140 is driven by the energy transmitted from the inverter 130, and the motor 140 transmits the regenerative energy to the inverter 130.

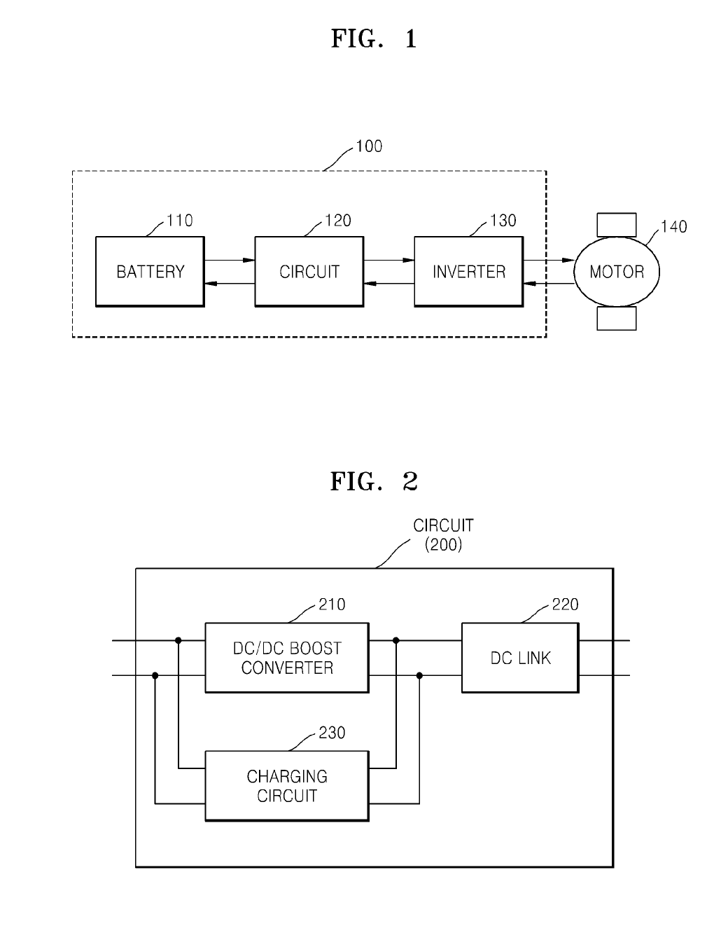

FIG. 2 is a diagram showing a circuit 200 as an example of the circuit 120 shown in FIG. 1 according to some example embodiments. The circuit 200 includes a DC/DC boost converter 210, a DC link 220, and a charging circuit 230.

The DC/DC boost converter 210 converts the DC (or DC voltage) to a DC (or DC voltage) having a different magnitude. For example, the DC/DC boost converter 210 boosts the DC voltage input from the battery 110 and outputs the DC voltage that is higher than the input DC voltage to the DC link 220. Otherwise, the DC/DC boost converter 210 reduces the DC voltage input from the DC link 220, and outputs the DC voltage that is lower than the input DC voltage to the battery 110.

The DC/DC boost converter 210 is connected to the charging circuit 230 in parallel. The DC/DC boost converter 210 is connected to the battery 110 and the DC link 220, and is connected to the charging circuit 230 in parallel. The DC/DC boost converter 210 receives energy from the battery 110, and converts the received energy to transmit the energy to the DC link 220.

The DC/DC boost converter 210 operates when the battery 110 is discharged. The DC/DC boost converter 210 receives the energy from the battery 110 and supplies the energy to the DC link 220 when the battery 110 is discharged.

The charging circuit 230 performs a balancing operation of a plurality of cells included in the battery 110. If there is a voltage difference or an SOC difference between the cells, the charging circuit 230 performs the balancing between the cells having different voltages or different SOCs from each other. That is, the charging circuit 230 makes the voltages or the SOCs of the cells, which are different from each other, be equal to each other. In an ideal case, since the cells have the same characteristics, the voltages or the SOCs of the cells are equal to each other during the charging or discharging. However, due to a technical limitation, a difference between capacities or impedances of the cells may occur. The difference of the characteristics between the cells causes over-charging or over-discharging of some cells. Therefore, if there is a voltage difference or an SOC difference between the cells during the charging or discharging operation, the charging circuit 230 balances the voltages or the SOCs of the cells, which are different. For example, the charging circuit 230 transfers energy to the other cell having a lower voltage or SOC so as to balance the voltages or the SOCs of two cells. The charging circuit 230 regularly measures the voltages or the SOCs of the cells, and performs the balancing between the cells based on the measured voltages or the SOCs.

The charging circuit 230 is connected to the DC/DC boost converter 210 in parallel. The charging circuit 230 is connected to the battery 110 and the DC link 220, and is connected to the DD/DC boost converter 210 in parallel. The charging circuit 230 receives energy from the DC link 220, and charges the battery 110 by using the received energy.

The charging circuit 230 operates when the battery 110 is charged. The charging circuit 230 charges the cells to make the voltages or the SOCs of the cells equal to each other. In more detail, the charging circuit 230 selects a cell having the lowest voltage or SOC, and supplies energy to the selected cell. Therefore, the selected cell is charged, and the charging circuit 230 measures the voltages or the SOCs of the cells again to select a cell having the lowest voltage or SOC and charge the selected cell. The charging circuit 230 repeatedly performs the processes of measuring the voltages or the SOCs of the cells and selecting the cell having the lowest voltage or SOC to charge the cell and, thus, the charging and balancing of the cells may be performed simultaneously.

The circuit 200 performs a boosting and a charging operation. When the battery 110 is discharged, the DC/DC boost converter 210 operates, and when the battery 110 is charged, the charging circuit 230 operates. That is, when the battery 110 is charged, the DC/DC boost converter 210 does not operate, and the regenerative energy from the motor 140 is transferred to the battery 110 via the charging circuit 230, not through the DC/DC boost converter 210.

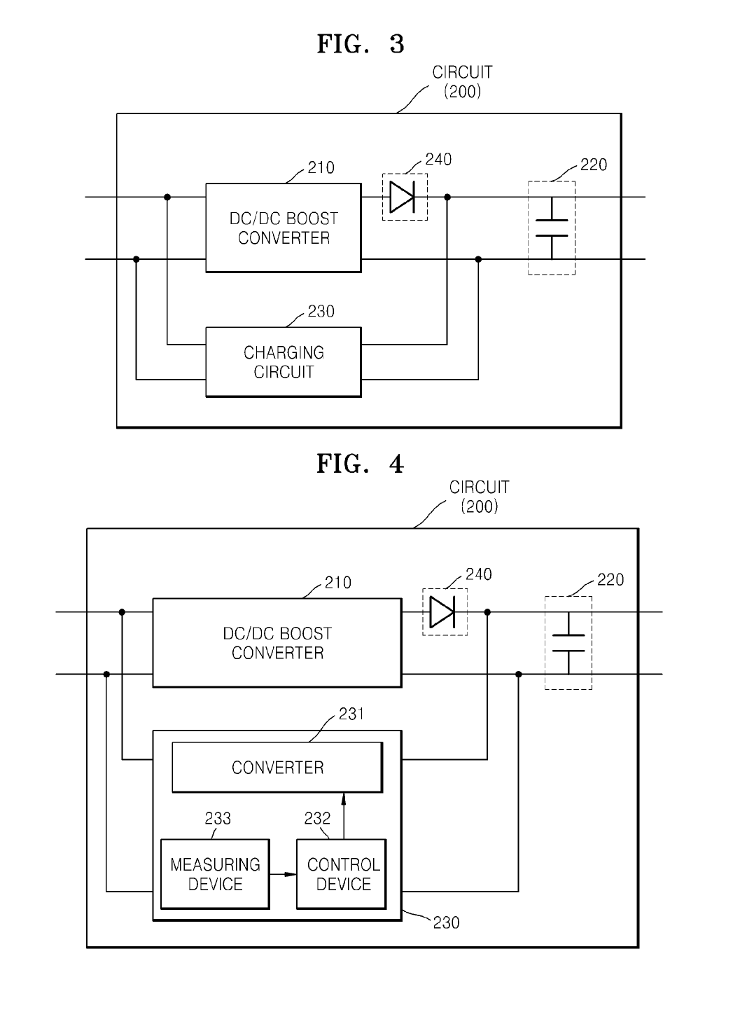

FIG. 3 is a diagram showing a circuit 200 as an example of the circuit 120 shown in FIG. 1 according to some example embodiments. The circuit 200 shown in FIG. 3 additionally includes a diode 240 between the DC/DC boost converter 210 and the DC link 220 of the circuit structure shown in FIG. 2. The diode 240 controls an electric current output from the DC/DC boost converter 210. The diode 240 transmits the electric current output from the DC/DC boost converter 210 to the DC link 220, and blocks the electric current output from the DC link 220 to the DC/DC boost converter 210. Therefore, the DC/DC boost converter 210 is not driven by the diode 240, when the battery 110 is charged.

For example, the DC link 220 includes a DC capacitor that stores the energy output from the DC/DC boost converter 210 or the energy output from the inverter 130.

FIG. 4 is a diagram showing a circuit 200 as another example of the circuit 120 shown in FIG. 1 according to some example embodiments. The charging circuit 230 includes a converter 231, a control device 232, and a measuring device 233. The converter 231 transfers the energy stored in the DC capacitor to a certain cell of the battery 110 by using a multi-winding transformer.

The measuring device 233 measures the voltages or the SOCs of the plurality of cells included in the battery 110. The measuring device 233 is connected to each of the cells to measure the voltage or the SOC of the each cell, and outputs the measured voltages or SOCs to the control device 232.

The control device 232 controls the converter 231 that uses the multi-winding transformer based on the voltages or the SOCs of the cells. The control device 232 receives the voltages or the SOCs of the cells from the measuring device 233, and selects a cell having the lowest voltage or the lowest SOC. The control device 232 controls switches of the converter 231 using the multi-winding transformer to transfer the energy stored in the DC capacitor to the selected cell. The control device 232 includes one or more processors. For example, the control device 232 may be a program realized in hardware capable of processing calculations or algorithms.

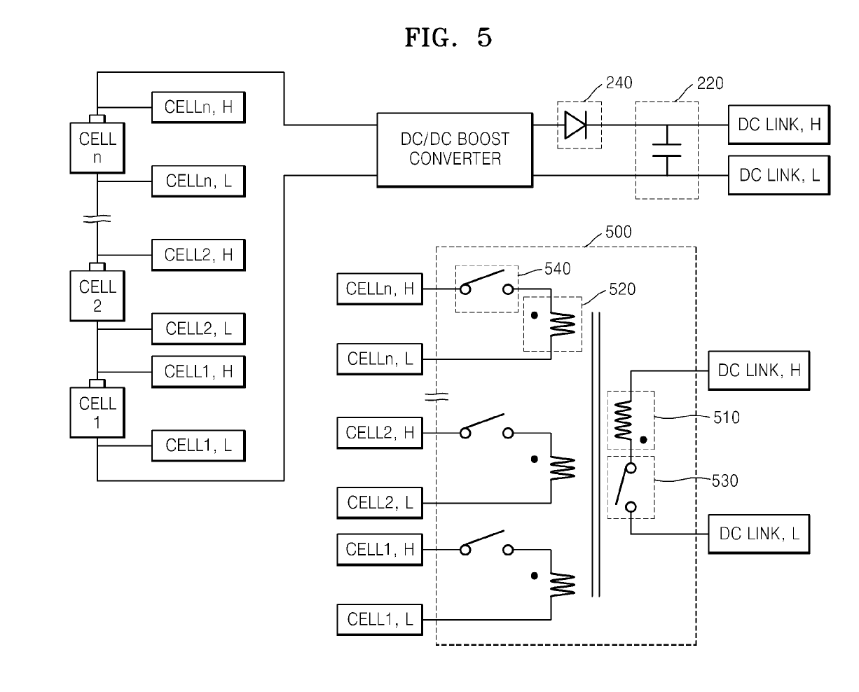

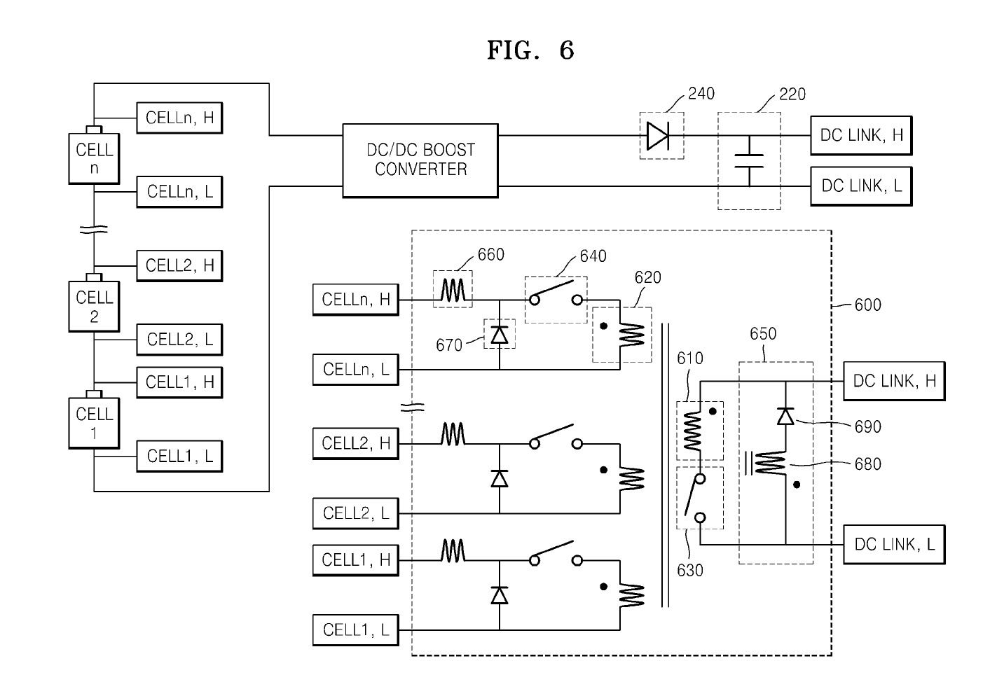

If there are two or more cells having the same voltages or the same SOCs, the control device 232 may select a cell based on an order in which the cells are connected. That is, the control device 232 assigns numbers to the cells in a connecting order, and may select the cell having smaller number. If a third cell and a fourth cell show the lowest voltage or SOC, the control device 232 has to select one of the third and fourth cells to charge. Here, if the cell having the smaller number has the priority, the control device 232 controls a switch connected to the third cell. A process of controlling the switches by the control device will be described below with reference to FIGS. 5 and 6.

FIG. 5 is a diagram showing a converter 500 as an example of the converter 231 of FIG. 4 according to some example embodiments. The converter 500 of FIG. 5 is an example of a flyback converter. Terminals shown with the same name in FIG. 5 denote that these terminals are electrically connected. For example, a terminal of the DC link 220 (DC link, H) is electrically connected to a terminal of the converter 500 (DC link, H).

The converter 500 selectively transfers the energy input from the DC link to the cells by using the multi-winding transformer. The converter 500 includes a first inductor 510 that is connected to the DC link 220 and a second inductor 520 that is connected to the cells of the battery 110. The first and second inductors 510 and 520 are correlated with each other. The first inductor 510 and the second inductor 520 have opposite polarities to each other. By adjusting a ratio between the number of windings of the first and second inductors 510 and 520, the converter 500 may transfer the energy to the cells at desired voltages. For example, if a ratio between the number of windings of the first inductor 510 and the number of windings of the second inductor 520 is 4:1 and a voltage applied to the terminal (DC link, H) is 400 V, a voltage applied to the second inductor 520 is 100 V. In other words, by adjusting the ratio between the number of windings in the first and second inductors 510 and 520, the converter 500 may transfer the energy to the cell at the voltage lower than that applied to the DC link 220.

The converter 500 further includes a switch 530 that is connected to the first inductor 510 in series and a switch 540 that is connected to the second inductor 520 in series. The switches 530 and 540 are controlled by the control device 232.

Operations of the charging circuit 230, including the flyback type converter 500, will be described below. That is, when the battery 110 is discharged, the energy of the battery 110 is transferred to the DC link 220 via the DC/DC boost converter 210, and the charging circuit 230 does not operate. When the battery 110 is charged, the regenerative energy generated by the motor 140 is transferred to the charging circuit 230 via the DC link 220. A terminal of the converter 500, which is connected to the DC link 220, is referred to as a primary terminal, and a terminal of the converter 500, which is connected to the battery 110, is referred to as a secondary terminal. The secondary terminal of the converter 500 is connected to (+) and (−) terminals of each of the cells in parallel.

When the control device 232 of the charging circuit 230 turns on the switch 530 of the primary terminal, the energy stored in the DC capacitor of the DC link 220 is stored in the first inductor 510 of the primary terminal. Then, the control device 232 turns off the switch 530 of the primary terminal, and turns on one of the switches of the secondary terminal. The energy stored in the first inductor 510 is transferred to the cell via the inductor connected to the turned on switch. Here, the control device 232 determines the switch of the secondary terminal, which is to be turned on, based on the voltages of the cells. For example, if a second cell among the cells ‘1’ through ‘n’ has the lowest voltage, the control device 232 turns on the switch that is connected to the second cell so that the second cell is charged.

The control device 232 repeatedly performs the process of controlling the switch that is connected to the cell having the lowest voltage or the lowest SOC based on the voltage or SOCs of the cells ‘1’ through ‘n’, and thus, the charging and balancing of the cells of the battery 110 are simultaneously performed by using the regenerative energy generated by the motor 140.

FIG. 6 is a diagram showing a converter 600 as an example of the converter 231 using a multi-winding transformer of FIG. 4 according to some example embodiments. A converter 600 of FIG. 6 is a forward converter. Other elements except for the forward converter 600 of FIG. 6 are the same as those of FIG. 5, and thus, descriptions thereof are not provided here.

The converter 600 uses a multi-winding transformer, and a primary terminal of the converter 600 includes a first inductor 610 and a switch 630 that are connected in series. The primary terminal of the converter 600 further includes a reset circuit 650, and the first inductor 610 and the reset circuit 650 are connected to each other in parallel. The reset circuit 650 includes an inductor 680 and a diode 690. The inductor 680 of the reset circuit 650 and the first inductor 610 have opposite polarities to each other and are correlated with each other. A secondary terminal of the converter 600 includes a second inductor 620 and a switch 640 that are connected to each other in series. In addition, the secondary terminal of the converter 600 further includes a diode 670 and an inductor 660, wherein the inductor 660 is connected to the switch 640 in series and the diode 670 is connected to the switch 640 in parallel. The first inductor 610 and the second inductor 620 are correlated with each other and have the same polarities as each other.

According to the charging circuit 230, including the forward type converter 600, when the battery 110 is discharged, the energy of the battery 110 is transferred to the DC link 220 via the DC/DC boost converter 210, and the charging circuit 230 does not operate. When the battery 110 is charged, the regenerative energy of the motor 140 is transferred to the charging circuit 230 via the DC link 220. For example, when charging the battery 110, the control device 232 turns on the switch 630 that is connected to the first inductor 610 and the switch 640 that is connected to the second inductor 620, at the same time. The energy is transferred to the cells via the forward converter 600. Here, the switch that is connected to the cell having the lowest voltage or SOC is controlled among the switches of the secondary terminal. For example, if the second cell has the lowest voltage or the lowest SOC, the control device 232 controls the switch that is connected to the second cell. When the energy is transferred to the cell, the control device 232 turns off the switch 630 of the primary terminal. When the switch 630 of the primary terminal is turned off, electric current flows to the reset circuit 650 and the converter 600 is initialized. The charging circuit 230 charges and balances the cells by repeatedly performing the above described processes.

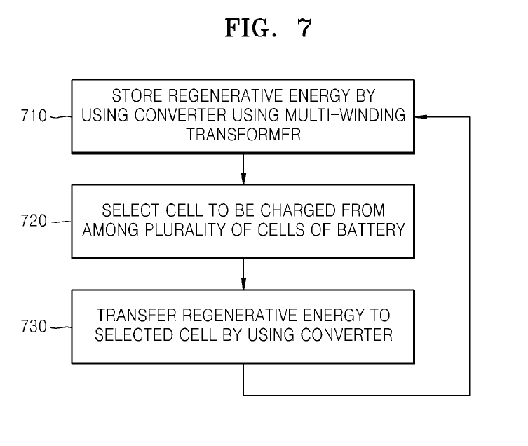

FIG. 7 is a flowchart for illustrating operations of the charging circuit 230 of FIG. 2. Therefore, the above descriptions about the circuit 120 of FIG. 2 may also be applied to FIG. 7.

When charging the battery 110 by using the regenerative energy of the motor 140, the converter 231 of the charging circuit 230 stores the regenerative energy (operation 710). The converter 231 receives the regenerative energy from the inverter 130. The converter 231 uses the multi-winding transformer. Since the converter 231 is connected to the DC/DC boost converter 210 in parallel, the converter 231 transfers the regenerative energy to the battery 110 without passing through the DC/DC boost converter 210.

In operation 720, the control device 232 of the charging circuit 230 selects a cell to be charged from among the plurality of cells included in the battery 110. The control device 232 selects the cell to be charged based on the voltages or the SOCs of the cells. For example, the control device 232 may select a cell having the lowest voltage or the lowest SOC among the plurality of the cells. The control device 232 selects the cells in an order of the voltage or the SOC level. The voltages or the SOCs of the cells are measured by the measuring device 233, and the measuring device 233 outputs the measured voltages or the SOCs to the control device 232. The measuring device 233 measures the voltages or the SOCs of the cells according to a measuring period (that may or may not be predetermined).

In operation 730, the charging circuit 230 transfers the regenerative energy to the selected cell by using the converter 231. The control device 232 of the charging circuit 230 controls the converter 231, that is, turning on/off of the switch that is connected to the selected cell so that the regenerative energy is transferred to the selected cell.

The charging circuit 230 performs the processes of measuring the voltages or the SOCs of the cells, and operations 710 through 730, and thus, the cells having the lowest voltage or SOC are sequentially charged and, accordingly, the charging and the balancing operations of the cells may be performed simultaneously.

The embodiments of the present invention can be written as computer programs and can be implemented in general-use digital computers that execute the programs using a computer-readable recording medium. Examples of the computer-readable recording medium include magnetic storage media (e.g., ROM, floppy disks, hard disks, etc.), and optical recording media (e.g., CD-ROMs or DVDs).

The circuit 120 may be used to balance the cells in a battery, wherein the cells are connected with each other in series. For example, the battery system may be applied to electric vehicles, hybrid electric vehicles, electric bikes, uninterruptible power supplies, or portable appliances.

The balancing of the cells included in the battery or the charging of the battery may be performed without using the DC/DC boost converter, and thus, loss of energy may be reduced.

The processes of charging the cell having the lowest voltage or the lowest SOC are repeatedly performed to thereby charge and balance the cells at the same time.

The energy is directly transferred between the cells via the converter using the multi-winding transformer, and thus, energy loss may be reduced.

The energy of an appropriate voltage may be supplied by adjusting the number of windings of the multi-winding transformer.

While example embodiments have been particularly shown and described, it will be understood by those of ordinary skill in the art that various changes in form and details may be made therein without departing from the spirit and scope of the present invention as defined by the following claims.

What is claimed is:

1. A circuit, comprising:
a direct current (DC)/DC boost converter connected to a battery that includes a plurality of cells;
a DC link connected between the DC/DC boost converter and an inverter; and
a charging circuit connected between the battery and the DC link;
wherein the charging circuit is connected to the DC/DC boost converter in parallel.

2. The circuit of claim 1, further comprising:
a diode connected between the DC/DC boost converter and the DC link.

3. The circuit of claim 1, wherein the charging circuit includes a second converter with a multi-winding transformer.

4. The circuit of claim 3, wherein the second converter comprises:
a first inductor connected to the DC link;
a second inductor connected to each of the plurality of cells in parallel;
a first switch connected to the first inductor in series; and
a second switch connected to the second inductor in series.

5. The circuit of claim 4, wherein a number of windings of the first inductor is greater than a number of windings of the second inductor.

6. The circuit of claim 4, wherein the charging circuit comprises:
a measuring device configured to measure voltages, states of charges (SOCs), or voltages and SOCs of the plurality of cells.

7. The circuit of claim 6, wherein the charging circuit further comprises:
a control device configured to control turning on and turning off of the first switch, and configured to control turning on and turning off of the second switch.

8. The circuit of claim 7, wherein the control device is configured to control the first switch based on the voltages, the SOCs, or the voltages and the SOCs measured by the measuring device, and is configured to control the second switch based on the voltages, the SOCs, or the voltages and SOCs measured by the measuring device.

9. The circuit of claim 4, wherein the second converter further comprises:
a reset circuit connected to the first inductor in parallel;
wherein the reset circuit comprises:
a diode; and
a mutual inductor having a polarity opposite to a polarity of the first inductor.

10. The circuit of claim 1, wherein when the battery is discharging, the DC/DC boost converter boosts a voltage of the battery and transfers the boosted voltage to the DC link.

11. A method of charging a battery using a regenerative energy of a motor, the method comprising:
storing the regenerative energy of the motor by using a converter with a multi-winding transformer;
selecting a cell to be charged from among a plurality of cells included in the battery; and
transferring the stored regenerative energy to the selected cell by using the converter.

12. The method of claim 11, wherein the selecting of the cell comprises:
selecting one of the plurality of cells based on voltages, states of charges (SOCs), or voltages and SOCs of the plurality of cells.

13. The method of claim 12, wherein the transferring of the stored regenerative energy comprises:
transferring the stored regenerative energy to the selected cell by controlling turning on and turning off of a switch connected to the selected cell.

14. The method of claim 11, wherein the selecting of the cell comprises:
selecting one of the plurality of cells having a lowest voltage or a lowest state of charge (SOC).

15. A computer-readable recording medium having embodied thereon a program for executing the method of claim 11 in a computer.
